(19) United States
(12) Patent Application Publication
(10) Pub. No.: US 2003/0065687 A1
(43) Pub. Date: Apr. 3, 2003

(54) Backup data management device and method

(75) Inventors: Hiroyuki Momiji, Tokyo (JP); Kousuke Fujinaga, Kanagawa (JP); Masanao Amimoto, Kanagawa (JP)

Correspondence Address: David A. Blumenthal, FOLEY & LARDNER, 3000 K Street, N.W. Suite 500, Washington, DC, 20007-5109, US

(73) Assignee: NEC CORPORATION

(21) Appl. No.: 09/817,194

(22) Filed: Mar. 27, 2001

(30) Foreign Application Priority Data
Mar. 27, 2000 (JP) 2000-087449

(51) Int. Cl. G06F 17/30

(52) U.S. Cl. 707/204; 707/200

(57) ABSTRACT

In a backup data management device of the invention, when the number of update times of either the first or the second divisional region exceeds a given number of times, blocks A and B assigned to first and second divisional regions, respectively, are exchanged. As a result of the block exchange, block B is newly assigned to the first divisional region, and block A is newly assigned to the second divisional region. As a result, after the block exchange, when operation data A is updated again, backup data corresponding to the operation data A in the second divisional region is updated.

### FIELD OF THE INVENTION

The present invention relates to a technique of managing backup data.

### BACKGROUND OF THE INVENTION

High reliability is required of electronic devices such as transmitting devices and the like. To this end, in such electronic devices, backing up of operation data is usually carried out to provide for unexpected circumstances.

An example of such a conventional technique is disclosed in Japanese Patent No. 2976897. In accordance with this technology, a package for memory is provided separately from a package for management. A copy of the data stored in the memory for work of the package for management is stored in a nonvolatile memory of the package for memory.

As a result, even if there is some problem with the package for management itself, this does not affect the package for memory. By using the backup data stored in the package for memory, the contents of the memory for work of the package for management after restoration can be restored. Further, even if there is some problem with the package for memory itself, this does not affect the package for management. By copying the backup data to the package for management, the contents of the nonvolatile memory of the package for memory after restoration can be easily restored.

In this way, backing up of data at a transmission device can be made even more reliable.

The above-described conventional techniques are excellent with respect to the point that backing up of data can be made even more reliable.

However, in a conventional transmission device, the storage region within the backup memory is fixed for each item of operation data which is the object of backing up. Thus, there is the tendency for the writing load to concentrate at particular regions of the backup memory. As a result, if the number of update times of a specific region exceeds a limit number of times, it is necessary to replace the entire backup memory despite the fact that the written data of the other regions have hardly been updated. In this way, the replacement lifespan of the backup memory is determined by the number of update times of the specific region in which the writing load concentrates. Thus, a problem arises in that the replacement lifespan of the backup memory is shortened.

### SUMMARY OF THE INVENTION

The present invention was developed in light of the above-described circumstances, and an object of the present invention is to provide a backup memory management device and method in which concentration of a writing load at a specific region of the backup memory can be avoided, and the lifespan of the backup memory itself can be lengthened.

In order to achieve this object, a backup data management device relating to a first aspect comprises: a first table which shows correspondence between blocks of a number equal to a number of a plurality of divisional regions into which a backup memory is equally divided, and respective operation data; a second table showing allotment of the blocks to the respective divisional regions; a block determining section which, each time an operation data is updated, determines the block corresponding to that operation data, with reference to the first table; a region determining section which, with reference to the second table, determines the divisional region to which the block which is determined by the block determining section, is allotted an updating section for updating backup data of updated operation data, within the divisional region determined by the region determining section; a counter for counting, for each divisional region, a backup data number of update times; and a block exchanging section which, in a case in which a number of update times of any of the divisional regions reaches a given number of times, changes, at the second table, the blocks allotted to that divisional region to another block, and moves the backup data stored in that divisional region to another divisional region in accordance with a change in block allotment, and initializes a count value of the counter for the number of update times of the divisional region whose allotted block has been changed.

In this way, in accordance with the backup data management device of the present invention, the allotted block of a divisional region whose number of update times has exceeded a given number of times is changed. Thus, concentration of writing load at a particular region of the backup memory can be avoided, and the writing load can be dispersed. As a result, the lifespan of the entire backup memory can be lengthened.

In accordance with the invention of a second aspect, there is provided a structure further comprising: a work region wherein when the backup data stored in the divisional region is moved, the backup data is temporarily shunted to the work region.

In this way, if a work region is provided and the backup data is temporarily shunted thereto, the backup data can be easily moved in accordance with the block allotment.

A backup data managing method of a third aspect comprises the steps of: dividing a backup memory equally into a plurality of divisional regions; making respective operation data correspond to respective blocks of a number equal to a number of the divisional regions; allotting the blocks to the divisional regions, respectively; each time an operation data is updated, updating backup data of that operation data within a divisional region to which the block which corresponds to that operation data, is allotted; counting, for each divisional region, a backup data number of update times; and in a case in which a number of update times of any of the divisional regions reaches a given number of times, changing the block allotted to that divisional region to another block, and moving the backup data stored in that divisional region to another divisional region in accordance with a change in block allotment, and initializing the number of update times of the divisional region whose allotted block has been changed.

In this way in accordance with the backup data managing method of the present invention, the allotted block of a divisional region whose number of update times has exceeded a given number of times is changed. Thus, concentration of writing load at a particular region of the backup memory can be avoided, and the writing load can be dispersed. As a result, the lifespan of the entire backup memory can be lengthened.

In accordance with the invention of a fourth aspect, there is provided a method in which in the changing of the block allotment, at all of the divisional regions, allotted blocks are shifted in order to a next blocks; and in the moving of the backup data stored in the divisional regions, backup data stored in one of the divisional regions is temporarily shunted to a work region, and backup data stored in the respective divisional regions are moved in order in accordance with a changed allotment of blocks.

In this way, if the allotted blocks of all of the divisional regions are shifted in order, the numbers of update times of the respective divisional regions are made equal, and the writing load of a particular region can be even more effectively dispersed. As a result, the lifespan of the entire backup memory can be lengthened even more.

In accordance with the invention of a fifth aspect, there is provided a method in which a number of divisional regions is an even number, and the blocks are allotted to the divisional region such that blocks which correspond to operation data having a high updating frequency and blocks which correspond to operation data having a low updating frequency are aligned alternately.

In this way, in a case in which the allotted blocks of the respective divisional regions are shifted one by one, by changing the blocks, a block having a low number of update times can be newly allotted to a divisional region to which is allotted a block having a high number of update times. On the other hand, by changing the blocks, a block having a high number of update times can be newly allotted to a divisional region which has been allotted a block having a small number of update times. Thus, the numbers of update times of the respective divisional region can effectively be made uniform.

In accordance with the invention of a sixth aspect, there is provided a method in which in the changing of the block allotment, a block, which is allotted to a divisional region whose number of update times reaches a given number of times, is exchanged with a block which has a lowest number of update times.

In this way, by merely exchanging the block having the largest number of update times and the block having the smallest number of update times the concentration of updating load at a particular region can be easily mitigated. As a result, the lifespan of the entire backup memory can be lengthened.

### BRIEF DESCRIPTION OF THE DRAWINGS

FIGS. 1A through 1C are schematic views for explaining the concept of a back-up data managing method of the present invention.

FIG. 2 is a block diagram for explaining a structure of a back-up memory management device of a first embodiment.

FIG. 3 is a flowchart for explaining the back-up memory managing method.

FIGS. 4A and 4B are schematic views for explaining a block exchange method in the first embodiment.

FIGS. 5A and 5B are schematic views which continue on from FIG. 4B.

FIGS. 6A through 6C are schematic views for explaining an example of a method of exchanging back-up data accompanying the exchange of blocks.

FIGS. 7A and 7B are schematic views which continue on from FIGS. 6C.

FIGS. 8A through 8C are schematic views for explaining another example of a method of exchanging back-up data accompanying the exchange of blocks.

FIGS. 9A through 9D are schematic views which continue on from FIG. 8C.

FIGS. 10A and 10B are schematic views for explaining a block exchange method in a second embodiment.

FIGS. 11A and 11E are schematic views which continue on from FIG. 10B.

FIG. 12 is a block diagram for explaining a structure of a back-up data management device of a third embodiment.

### DESCRIPTION OF THE PREFERRED EMBODIMENTS

[Concept of Back Up Data Managing Method]

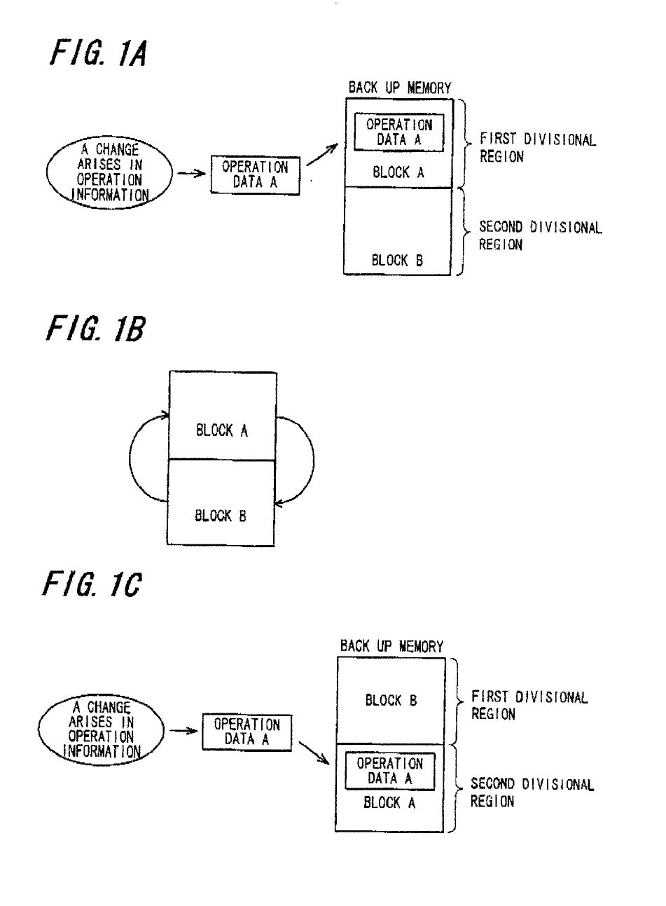

First, a summary of the backup data managing method of the present invention will be described with reference to FIG. 1.

Here, the backup memory is divided into two regions which are a first divisional region and a second divisional region. Further, operation data A, which is updated frequently, is made to correspond to block A among two blocks which are block A and block B.

In Fig. 1A, first, the block A is allotted to the first divisional region, and the block B is allotted to the second divisional region. Accordingly, when the operation data A is updated, the backup data corresponding to the operation data A of the first divisional region is updated.

Conventionally, when the storage region of the backup data of operation data A is fixed to the first divisional region, only the number of update times of the first divisional region increases. As a result, if left as is, while the backup data will hardly be updated at all in the divisional region 2, the number of update times in the first divisional region alone will exceed the limit of number of update times of the backup memory. In this case, the entire backup memory will have to be replaced.

Thus, here, when the number of update times of either the first or the second divisional region exceeds a given number to times, as shown in FIG. 1B, the allotted blocks A and B of the first and second divisional regions are exchanged. As a result of the block exchange, the block B is newly allotted to the first divisional region, and the block A is newly allotted to the second divisional region.

As a result, after block exchange, when the operation data A is updated again, as illustrated in FIG. 1C, the backup data corresponding to the operation data A in the divisional region 2 is updated.

By exchanging the blocks allotted to the divisional regions in this way, a concentration of writing load at a particular region of the backup memory can be avoided, and the writing load can be dispersed. As a result, the lifespan of the entire backup memory can be lengthened, and reliability can be improved.

Next, embodiments of the backup data management device and managing method of the present invention will be described with reference to the drawings.

### FIRST EMBODIMENT

First, the structure of a backup data management device of the first embodiment will be described with reference to FIG. 1.

As shown in FIG. 1, the backup data management device of the first embodiment is structured by a first table 1, a block determining section 2, a second table 3, a region determining section 4, a backup data updating section 5, a counter 6, a block exchanging section 7, and a RAM 8 which serves a work region.

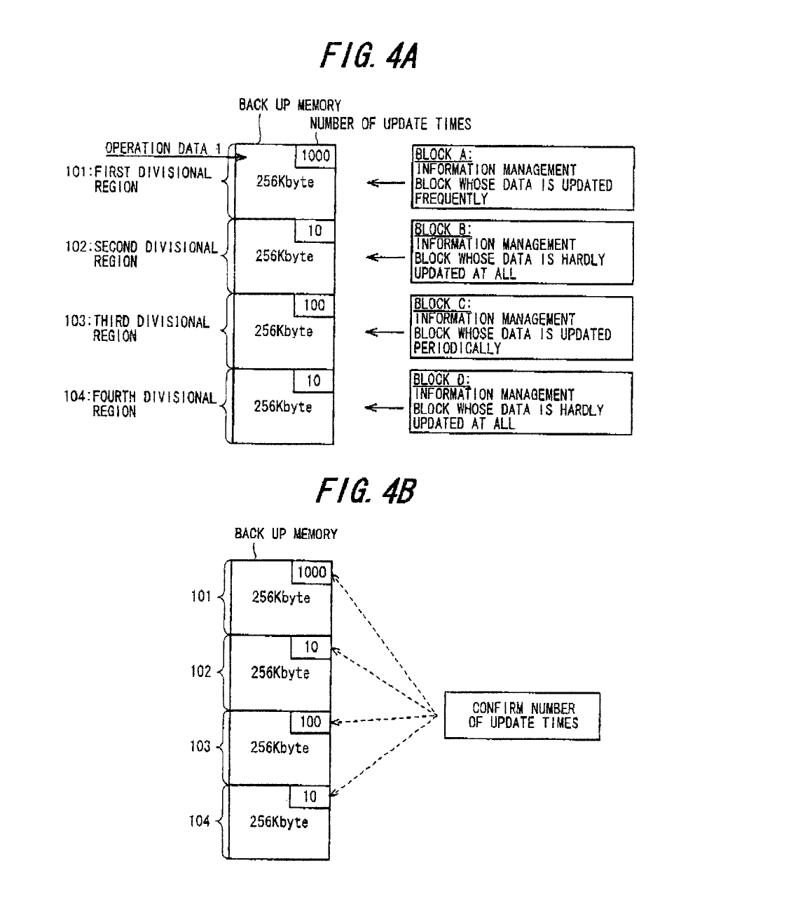

A backup memory 20 is structured by an EEPROM. As shown in FIG. 4A, the backup memory 20 has a storage capacity of 1 Mbyte (megabyte) which is divided into four equal regions which are first through fourth divisional regions each of 256 Kbyte.

The first table 1 shows the correspondence between respective operation data and blocks. The number of blocks is equal to the number of the plural divisional regions into which the backup memory is equally divided.

Following Table 1 is an example of the correspondence between the blocks and the operation data, such as the device addresses of a transmission device.

TABLE 1

| | |
|---|---|
| Data 1 | Block A |
| Data 2 | Block A |
| Data 3 | Block B |
| Data 4 | Block B |
| Data 5 | Block C |
| Data 6 | Block C |
| Data 7 | Block D |
| Data 8 | Block D |

As can be seen from Table 1, operation data 1 and 2 correspond to block A, and operation data 3 and 4 correspond to block B. Thereafter, similarly, operation data 5 and 6 correspond to block C, and operation data 7 and 8 correspond to block D.

Further, the second table 3 shows the allotment of the respective blocks A through D to the first through fourth divisional regions. Here, first, the blocks A through D are allotted in order to the first through fourth divisional regions.

In particular, in the present embodiment, the respective blocks are allotted to the divisional regions such that blocks corresponding to operation data having a high frequency of being updated, and blocks corresponding to operation data having a low frequency of being updated, are aligned alternately. Namely, as shown in FIG. 4A, data having a high updating frequency, e.g., events or status changes within the device, are made to correspond to blocks A and C. On the other hand, data having a low updating frequency are made to correspond to blocks B and D.

In the backup memory, usually, data management is carried out by a page management system. In this case, the size of one page is fixed, and for one page, one item of information (data) is managed. Accordingly, one block in the present embodiment corresponds to one page or plural pages in the page management system.

However, the number of pages corresponding to one block is the same for each block. For example, in the corresponding relationships shown in above Table 1, each block corresponds to two pages. Further, the entire number of pages of the backup memory is an integer multiple of the number of pages per blocks. In particular, in the present embodiment, because there are four blocks, the total number of pages is an even multiple (a multiple of four).

Then, when a command to update the operation data is inputted from an input device 11, a command analyzing section 12 analyzes the command, and carries out updating processing of the operation data. At a backup data management device 10 as well, updating of the backup data of that operation data is instructed.

When updating of the backup data is instructed, the block determining section 2 refers to the first table 1, and determines the block corresponding to that operation data. For example, if the operation data is “data 1”, “block A ” is determined from the first table shown in above Table 1.

Next, with reference to the second table, the region determining section 4 determines the divisional region to which the block which is determined at the block determining section 3, is allotted. For example, in the case of the allotment shown in FIG. 4A, the “first divisional region” is determined as the allotted divisional region for “block A”.

Then, the backup data updating section 5 updates the backup data of the updated operation data 1, which backup data is in the first divisional region determined at the region determining section 4.

At this time, a counter 6 counts the number of update times of the backup data for each divisional region.

Then, when the number of update times at any divisional region has reached a given number of times, the block exchanging section 7 changes, in the second table 3, the block which is allotted to that divisional region to another block. Further, the block exchanging section 7 moves the backup data, which is stored in that divisional region, to another divisional region in accordance with the change in the allotment of the blocks. Then, the block exchanging section 7 resets the counted value of the counter 6 for the number of update times of the changed divisional regions of the allotted blocks.

The RAM 8 is provided for the temporary shunting of backup data at the time when the backup data stored in the divisional region is moved. Thus, the RAM 8 must have a storage capacity corresponding to one or plural divisional regions.

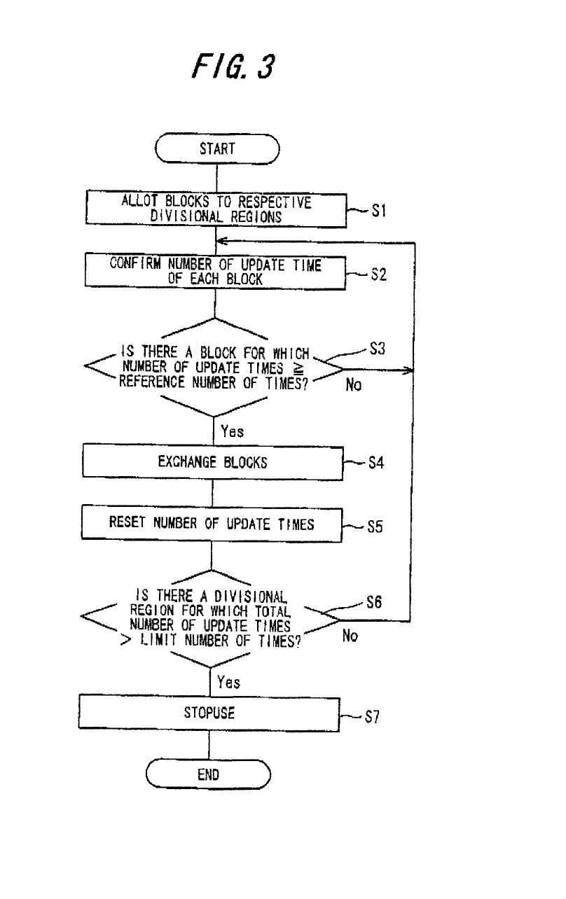

Next, an example of operation of the backup data management device 10 will be described with reference to FIGS. 3, 4 and 5, and centering or the operation of the block exchanging section 7.

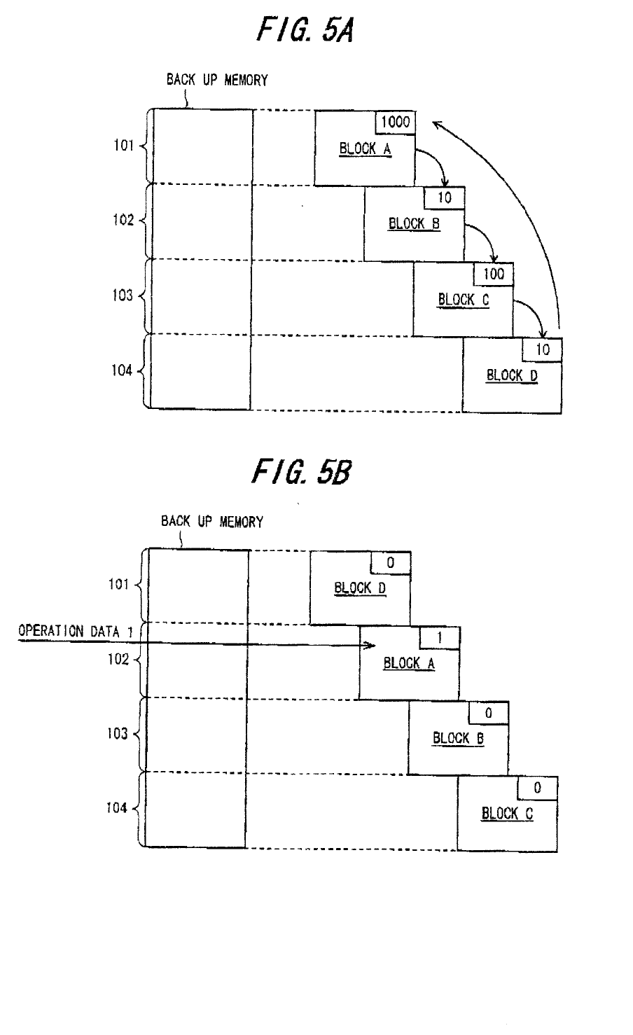

FIG. 3 is a flowchart for explaining an example of operation of the backup data management device, and FIGS. 4 and 5 are schematic views for explaining block exchange.

First, as shown in FIG. 4A, the respective blocks A through D are allotted (step S1 in FIG. 3) to divisional regions 101 through 104, such that the blocks corresponding to operation data having a high updating frequency in the second table 3, and blocks corresponding to operation data having a low updating frequency are aligned alternately.

Note that the number in the upper right portion of each of the divisional blocks represents the number of update times of the backup data in that divisional region.

Then, the block exchange section 7 confirms the number of update times of each block which the counter 6 has counted (step S2 in FIG. 3). Specifically, it is confirmed whether or not the number of update times of any divisional region has reached a given number of times (e.g., 1000 times) (step 83 in FIG. 3).

Note that the confirming of the updating number of time may be carried out each time backup data is updated, or may be carried out periodically, for example, once a day.

In the example shown in FIG. 4B, the number of update times of the first divisional region has reached the given number of times which is 1000 times. Thus, the block exchanging section 7 carries out block exchange (step 4 in FIG. 3).

In the present embodiment, during block exchange, as shown in FIG. 4C, at all of the divisional regions, the allotted blocks are shifted sequentially to the next block. As a result, as shown in FIG. 4D, the block A is newly allotted to the second divisional region 102, the block B is newly allotted to the third divisional region 103, the block C is newly allotted to the fourth divisional region 104, and the block D is carried up so as to be newly allotted to the first divisional region 101.

As a result, when the operation data 1 is updated after block exchange, the backup data is updated at the second divisional region 102 to which block A, which corresponds to the operation data 1, is newly allotted.

Because the number of divisional regions, i.e., the number of blocks, is even (4), even it the block D is carried up, the blocks are still arranged such that the blocks having a high updating frequency and the blocks having a low updating frequency are aligned alternately.

During this block exchange, the backup data stored in the respective divisional regions as well are moved to other divisional region in accordance with the change in the block allotment.

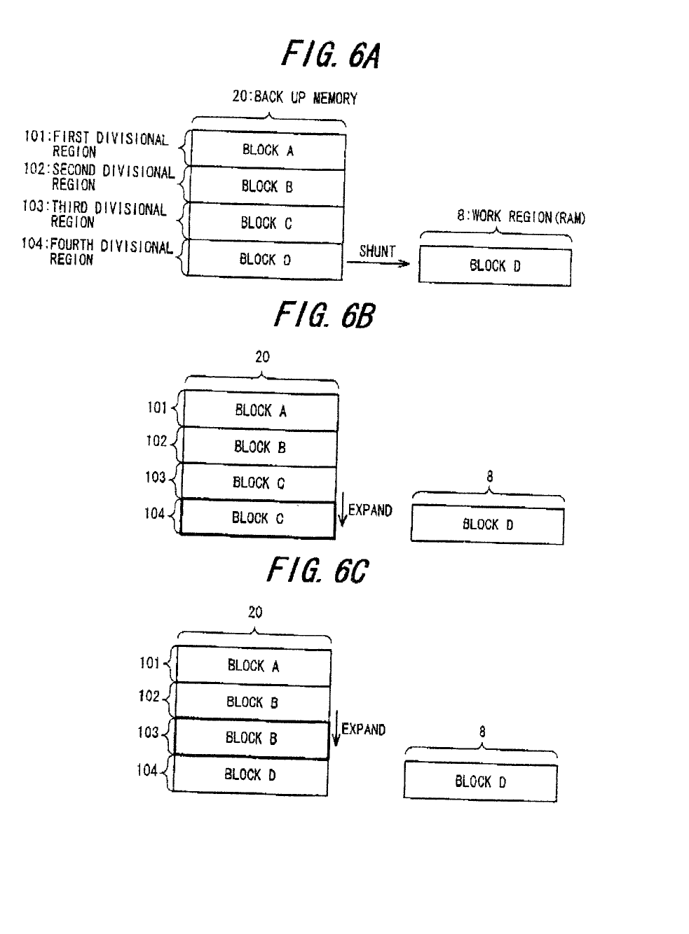

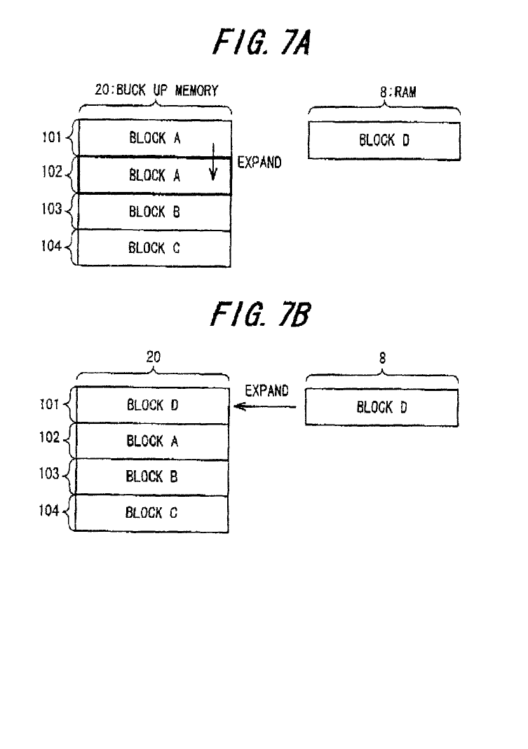

Here, an example of the method of moving backup data will be explained with reference to FIGS. 6 and 7.

First as illustrated in FIG. 6A, the backup data, which is stored in the fourth divisional region 104 and which corresponds to the block D, is temporarily shunted to the RAM 8. In this case, the RAM 8 may have a storage capacity corresponding to one block.

Next, as shown in FIG. 6B, the backup data, which is stored in the third divisional region 103 and which corresponds to the block C, is expanded to the fourth divisional region 104.

Next, as shown in FIG. 6C, the backup data, which is stored in the second divisional region 102 and which corresponds to the block B, is expanded to the third divisional region 103.

Next, as shown in FIG. 7A, the backup data, which is stored in the first divisional region 101 and which corresponds to the block A, is expanded to the second divisional region 102.

Lastly, as shown in FIG. 7B, the backup data, which has been shunted to the RAM 8 and which corresponds to the block D, is expanded to the first divisional region 101.

In this way, the backup data can be shifted at all of the divisional regions.

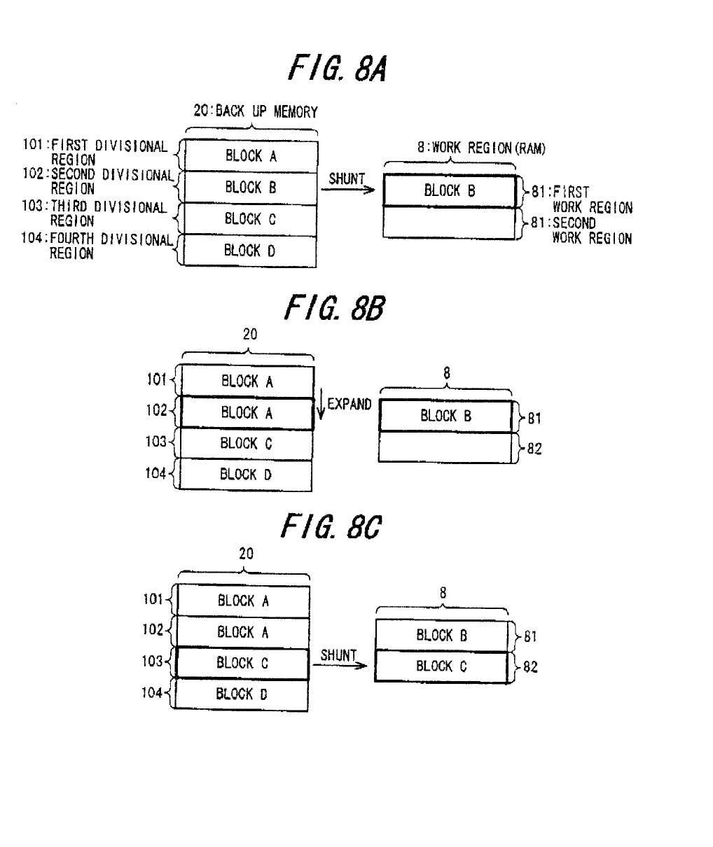

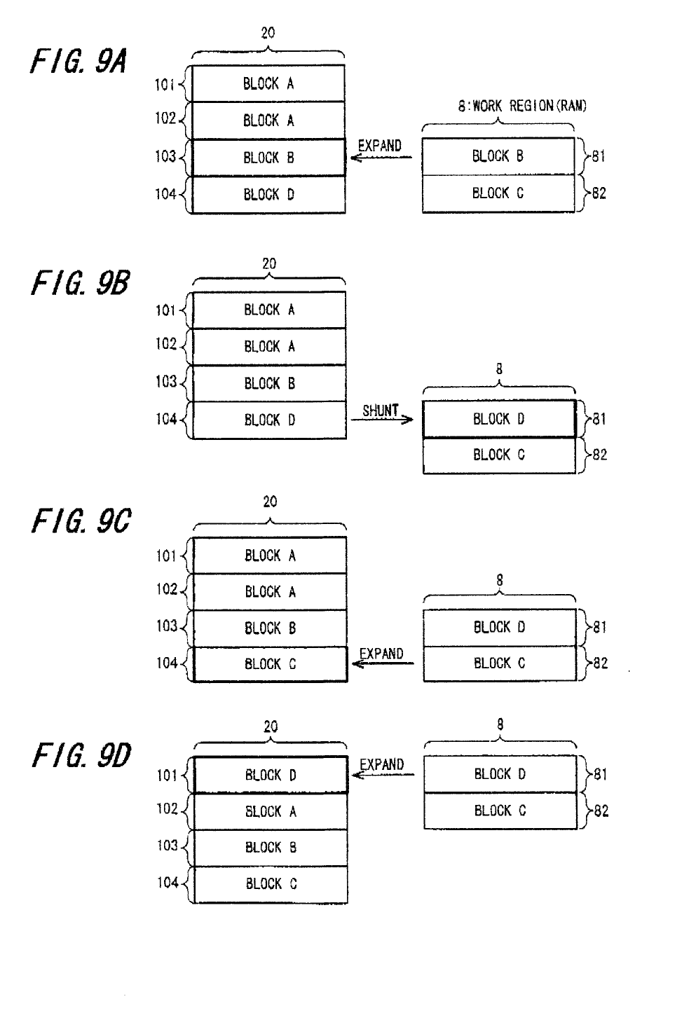

Next, another example of a method of moving backup data will be described with reference to FIGS. 8 and 9.

In this example, the RAM 8 is provided with first and second work regions 81 and 82 so as to have a storage capacity corresponding to two blocks.

First, as shown in FIG. 8A, the backup data, which is stored in the second divisional region 102 and which corresponds to the block B, is shunted to the first work region 81.

Next, as shown in FIG. 8B, the backup data, which is stored in the first divisional region 101 and which corresponds to the block A, is expanded to the second divisional region 102.

Note that the data of the block A may be expanded to the second divisional region 102 after being temporarily shunted to, for example, RAM 1.

Next, as shown in FIG. 8C, the backup data, which is stored in the third divisional region 103 and which corresponds to the block C, is shunted to the second work region 82.

Next, as shown in FIG. 9A, the backup data, which has been shunted to the first work region 81 and which corresponds to the block B, is expanded to the third divisional region 103.

Next, as shown in FIG. 9B, the backup data, which is stored in the fourth divisional region 104 and which corresponds to the block D, is shunted to the first work region 81.

Next, as shown in FIG. 9C, the backup data, which has been shunted to the second work region 84 and which corresponds to the block C, is expanded to the fourth divisional region 104.

Lastly, as shown in FIG. 9D, the backup data, which has been shunted to the first work region 81 and which corresponds to the block D, is expanded to the first divisional region 101.

In this way as well, the backup data can be shifted at all of the divisional regions.

Then, after block exchange has been carried out, the backup data is updated at the divisional regions to which blocks have been newly allotted. For example, as shown in FIG. 5B, the backup data of the operation data 1 is updated at the second divisional region 102 to which the block A has been newly allotted.

Then, in the present embodiment, after block exchange has been carried out, the block exchanging section 7 resets the numbers of update times of the respective divisional regions which have been counted at the counter (step S5 in FIG. 3).

Further, it is confirmed whether or not the total number of update times has exceeded a limit number of times (e.g., 10,000 times). If the limit number of times has been exceeded, use of the backup memory is stopped (step S6 in FIG. 4).

In this way, if the allotted blocks of all of the divisional regions are moved in order, the numbers of update times of the respective divisional regions are made uniform, and the writing load of a particular region can be dispersed more effectively. As a result, the lifespan of the entire backup memory can be lengthened even more.

For example, in a backup memory having a limit number of update times of 10,000 times, the number of update times of block A reaches 1000 times in a month. In this case, after about nine months, the number of update times of block A will reach the limit number of update times. Accordingly, if a conventional system is used, the lifespan of the backup memory will be about 10 months.

Here, in the present embodiment, each time the number of update times reaches 1000 times, the divisional region to which block A is allotted is changed successively. If the total numbers of update times of the four divisional regions are made to be about equal, in a case in which the numbers of update times of blocks other than block A are so small as to be negligible, the lifespan of the backup memory can be extended ideally to about 40 months, or four times that of the conventional art. Further, this extending of the lifespan of the backup memory 20 contributes to an improvement in the reliability of the backup memory 20.

### MODIFIED EXAMPLE

In the above-described first embodiment, the allotment of blocks is changed at all of the divisional regions. However, in the present invention, in the changing of the allotment of blocks, a block, which is assigned to a divisional region whose number of update times has reached a given number of times, may be exchanged with the block having the smallest number of update times. For example, in the case of the allotment shown in FIG. 4A, it suffices to merely exchange the block A and the block B.

In this way, by exchanging the block A, which has the highest number of update times, and the block B, which has the lowest number of update times, a concentration of updating load at the first divisional region 1010 can be mitigated. As a result, the lifespan of the overall backup memory can be lengthened.

### SECOND EMBODIMENT

Next, a second embodiment of the present invention will be described.

The second embodiment is the same as the above-described first embodiment, except for the point that the backup memory is divided into 8 equal regions.

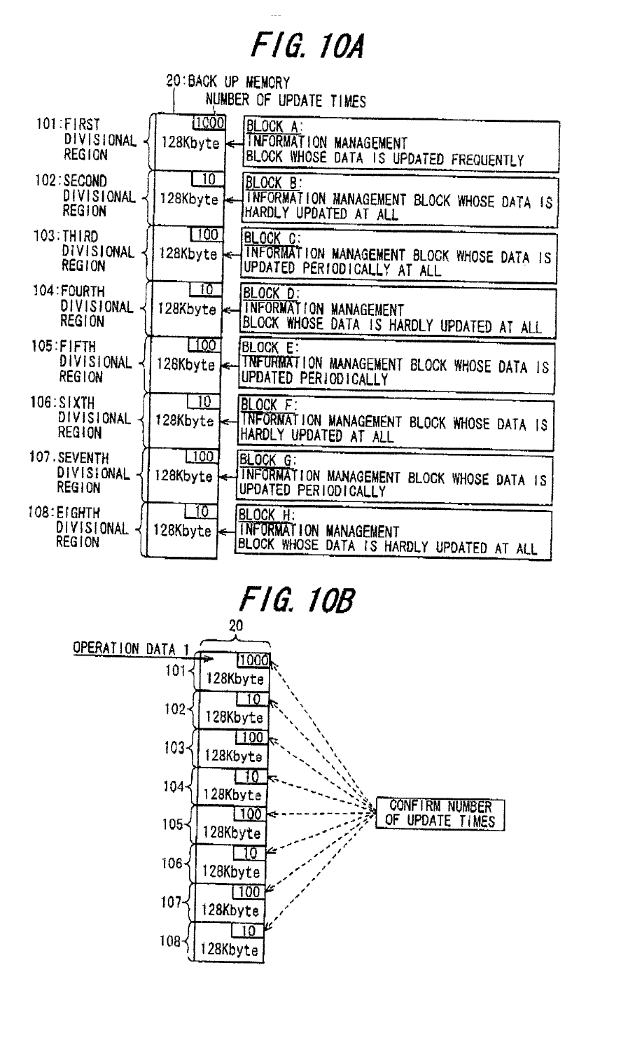

In the present embodiment, the respective operation data are made to correspond to respective ones of eight blocks A through H, which are of a number which is equal to the number of divisional regions. Further, in the second embodiment as well, as illustrated in FIG. 10A, the blocks A through H are respectively allotted to first through eighth divisional regions 101 through 108, such that blocks corresponding to operation data having a high updating frequency and blocks corresponding to operation data having a low updating frequency are aligned alternately.

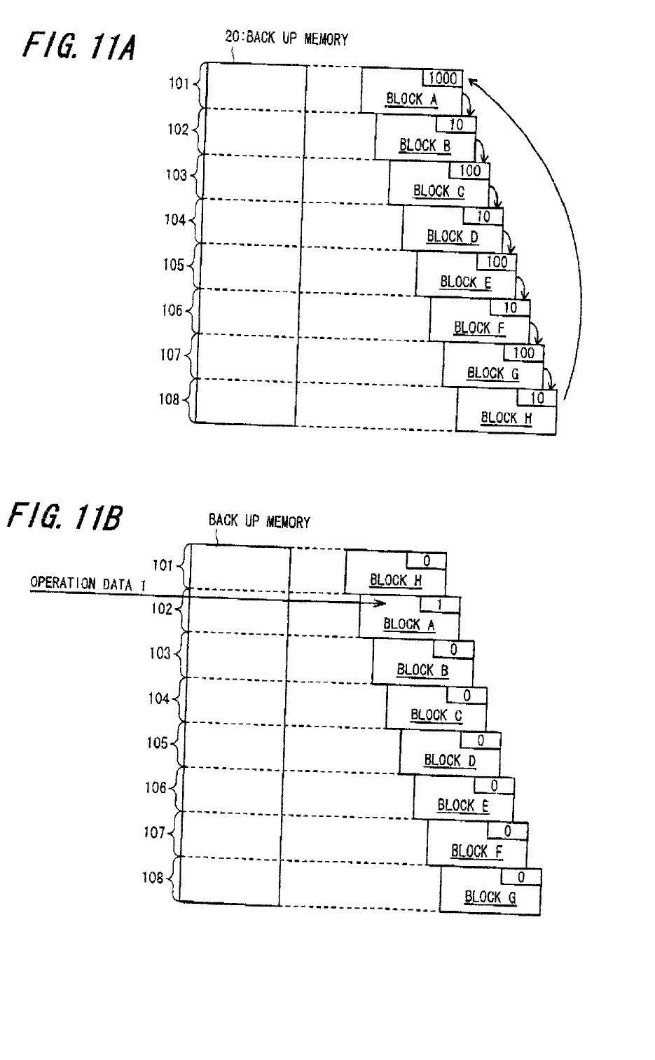

Next, as shown in FIG. 10B, the number of update times of each block is confirmed. Then, when the number of update times reaches a given number, as shown in FIG. 11A, at all of the divisional regions, the allotted blocks are shifted, in order, to the next block. Moreover, at the time of block exchange, the backup data stored in the respective divisional regions are moved to other divisional regions in accordance with the change in the allotment of the blocks.

As a result of the block exchange, as shown in FIG. 11B, when the operation data 1 is updated after block exchange, the backup data is updated at the second divisional region 102 to which the block A corresponding to the data 1 is newly allotted.

In this way, if the allotted blocks of all of the divisional regions are shifted in order, the numbers of update times of the respective divisional regions can be made to be uniform, and the writing load of a particular region can be more effectively dispersed. As a result, the lifespan of the entire backup memory can be lengthened even more.

In the second embodiment in particular, if the total numbers of update times at the eight divisional regions become about equal, in a case in which the numbers of update times of blocks other than block A are so small as to be negligible, the lifespan of the backup memory can be extended ideally to about eight times that of the conventional art.

Similarly, if the backup memory is divided into n equal parts (wherein n is an even number) and all of the blocks are shifted, it can be expected that the lifespan of the backup memory can be ideally extended to about n times that in a case in which there is no block exchanging.

### THIRD EMBODIMENT

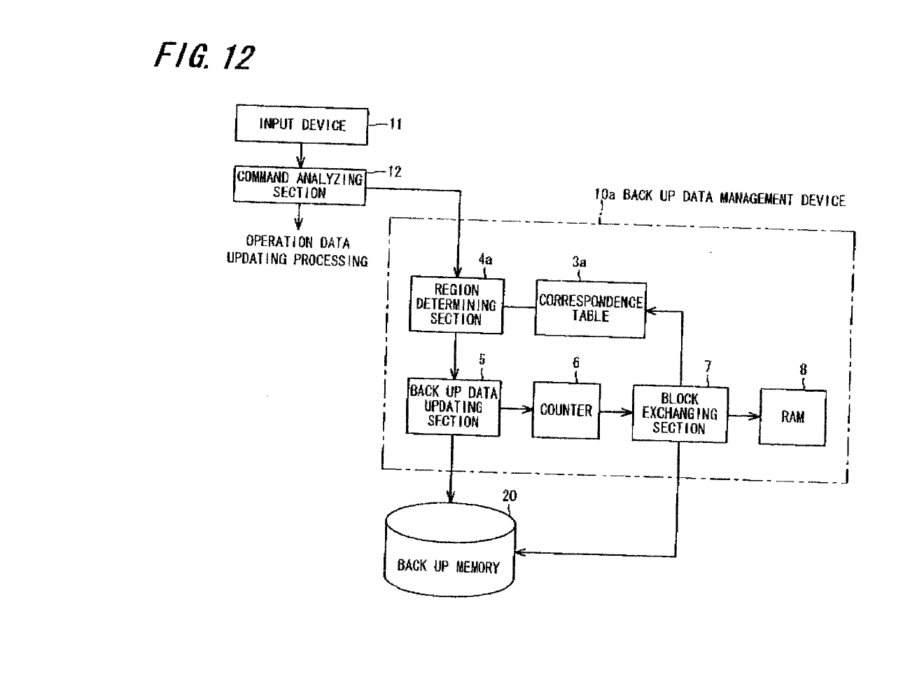

Next, a third embodiment of the present invention will be described with reference to FIG. 12.

In the third embodiment, the operation data and the blocks are made to correspond in a one-to-one correspondence as shown in following Table 2. Namely, in the page management system, one block corresponds to one page.

TABLE 2

| | |
|---|---|
| Data 1 | Block A |
| Data 2 | Block B |
| Data 3 | Block C |
| Data 4 | Block D |

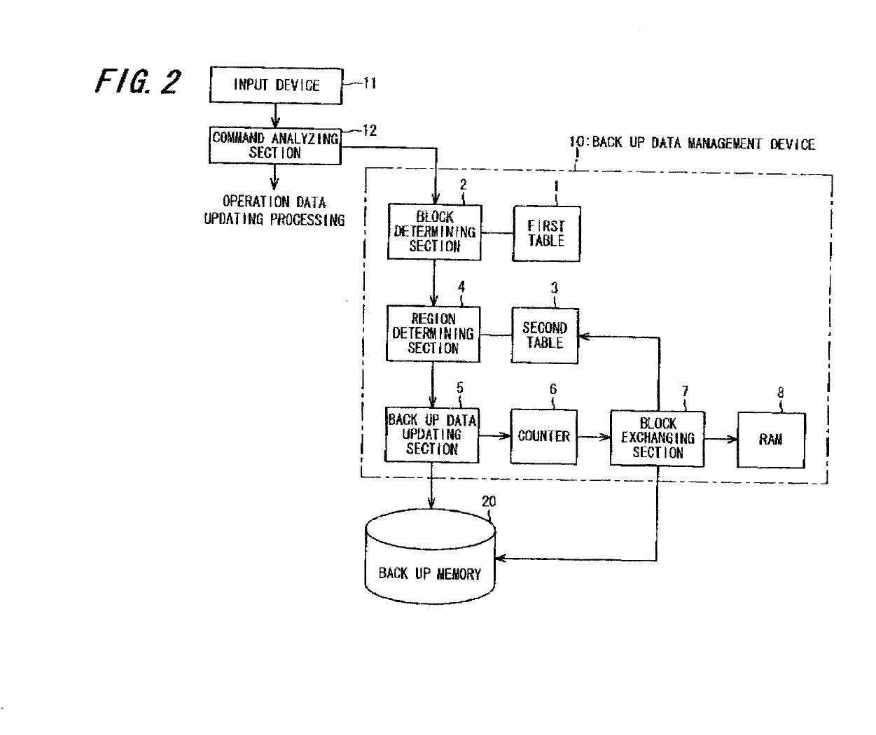

As a result, in a backup data management device 10a of the third embodiment, the second Table 3 shown in FIG. 2 is used also as the first Table 1. Namely in a correspondence table 3a, the blocks are directly allotted in page units to the respective divisional regions, with one page in the page management system being one block. Then, at a region determining section 4a, the divisional region corresponding to the page of operation data is directly determined with reference to the correspondence Table 3a.

In the third embodiment, the other structures and the method of exchanging blocks is the same as that of the above-described first embodiment, and thus, detailed description thereof is omitted.

In the above-described embodiments, examples are described in which the present invention is structured by specific conditions. However, the present invention can be modified in various ways. For example, in the above-described embodiments, specific numerical values are mentioned as the given number of times at which block exchange is to be carried out. However, in the present invention, an arbitrary, appropriate value can be used as the given number of times.

As described above in detail, in accordance with the present invention, the allotted block of a divisional region whose number of update times has exceeded a given number of times is changed. Thus, concentration of the writing load at a particular region of the backup memory can be avoided, and the writing load can be dispersed. As a result, the lifespan of the entire backup memory can be lengthened, and the reliability of the backup memory can be improved.

In particular, in changing the allotment of blocks, if the allotted blocks are shifted in order for all of the divisional regions, the writing loads for the respective divisional regions can be made uniform. Thus, the lifespan of the backup memory can be made even more long.

What is claimed is:

1. A backup data management device comprising:
a first table which shows correspondence between blocks of a number equal to a number of a plurality of divisional regions into which a backup memory is equally divided, and respective operation data;
a second table showing allotment of the blocks to the respective divisional regions;
a block determining section which, each time an operation data is updated, determines the block corresponding to that operation data, with reference to the first table;
a region determining section which, with reference to the second table, determines the divisional region to which the block which is determined by the block determining section, is allotted;
an updating section for updating backup data of updated operation data, within the divisional region determined by the region determining section;
a counter for counting, for each divisional region, a backup data number of update times; and
a block exchanging section which, in a case in which a number of update times of any of the divisional regions reaches a given number of times, changes, at the second table, the block allotted to that divisional region to another block, and moves the backup data stored in that divisional region to another divisional region in accordance with a change in block allotment, and initializes a count value of the counter for the number of update times of the divisional region whose allotted block has been changed.

2. A backup data management device according to claim 1, further comprising: a work region wherein when the backup data stored in the divisional region is moved, the backup data is temporarily shunted to the work region.

3. A backup data managing method comprising the steps of:
dividing a backup memory equally into a plurality of divisional regions;
making respective operation data correspond to respective blocks of a number equal to a number of the divisional regions;
allotting the blocks to the divisional regions, respectively;
each time an operation data is updated, updating backup data of that operation data within a divisional region to which the block which corresponds to that operation data, is allotted;
counting, for each divisional region, a backup data number of update times; and
in a case in which a number of update times of any of the divisional regions reaches a given number of times, changing the block allotted to that divisional region to another block, and moving the backup data stored in that divisional region to another divisional region in accordance with a change in block allotment, and initializing the number of update times of the divisional region whose allotted block has been changed.

4. A backup data managing method according to claim 3, wherein
in the changing of the block allotment, at all of the divisional regions, allotted blocks are shifted in order to a next block; and
in the moving of the backup data stored in the divisional regions, backup data stored in one of the divisional regions is temporarily shunted to a work region, and backup data stored in the respective divisional regions are moved in order in accordance with a changed allotment of blocks.

5. A backup data managing method according to claim 4, wherein a number of divisional regions is an even number, and the blocks are allotted to the divisional region such that blocks which correspond to operation data having a high updating frequency, and blocks which correspond to operation data having a low updating frequency, are aligned alternately.

6. A backup data managing method according to claim 3, wherein in the changing of the block allotment, a block, which is allotted to a divisional region whose number of update times reaches a given number of times, is exchanged with a block which has a lowest number of update times.
